(19) United States
(12) Patent Application Publication
(10) Pub. No.: US 2003/0019735 A1
(43) Pub. Date: Jan. 30, 2003

(54) Bonding electrical components to substrates

(76) Inventors: David Malcolm Howie, Foxboro, MA (US); Rita Mohanty, East Greenwich, RI (US)

Correspondence Address: DAVID L. FEIGENBAUM, Fish & Richardson P.C., 225 Franklin Street, Boston, MA, 02110-0804, US

(21) Appl. No.: 09/918,145

(22) Filed: Jul. 30, 2001

(51) Int. Cl. H01H 1/10

(52) U.S. Cl. 200/512

(57) ABSTRACT

Methods are provided including (a) bonding separate conductive areas of an electrical component to a substrate using a conductive adhesive; and (b) bonding an area of the electrical component lying between the conductive areas to the substrate using a non-conductive adhesive.

### TECHNICAL FIELD

This invention relates to bonding electrical components to substrates.

### BACKGROUND

In a typical membrane switch, for example, a polyester substrate bears a silver-filled conductive ink in a pattern of conductors that forms an electrical circuit. Several conductor layers may be used, for example two conductor layers separated by a dielectric layer. Electrical components are bonded to the circuit using a conductive adhesive, e.g., a silver-filled epoxy adhesive, to provide a conductive interface between the components and the circuit.

A typical LED or diode bears a pair of spaced conductive pads, usually gold plated, on its back surface. These component pads are bonded to two corresponding pads on the substrate using dots or “beads” of conductive adhesive that are printed or dispensed onto the substrate pads. The electrical component is then placed onto the adhesive, and the adhesive is cured to bond the component in place. The bond between a component pad and a substrate pad defines an electrical contact point.

A typical process for bonding an LED to a substrate is shown in FIGS. 1-1B. As shown in FIG. 1, looking from the underside, a conductive ink is printed on a flexible substrate 10 to form printed conductive traces 1, 11 and to define a pair of pads 2, 12 to which an LED 4 is attached. (Substrate 10 is generally much larger than the area indicated by the dotted lines in FIGS. 1-3; the dotted lines indicate a portion of the substrate.) The substrate 10 may be, e.g., a sheet of transparent flexible polyester film. As shown in FIG. 1A, beads 3, 13 of conductive adhesive are then dispensed onto the pads 2, 12. FIG. 1B shows the LED 4 positioned over the pads 2, 12. The conductive adhesive has been displaced (squished) by the LED 4, and has migrated to regions 5 that are between the beads 3, 13.

Because the adhesive is heavily filled with silver particles to make it conductive, the shear strength of the adhesive is relatively low, and thus the strength of the bond between the component and the substrate is also relatively low. The component bond line failure that may occur as a result of this low bond strength may cause the membrane switch to fail.

In addition, because the conductive pads on the component are close together, the squished conductive adhesive may form a bridge 15 between the pads, electrically shorting the component.

### SUMMARY

The invention enables an electrical component to be bonded to a substrate with a relatively high bond strength and without shorting. These advantages can be provided without significantly increasing the cost of the membrane switch.

In one aspect, the invention features a method comprising (a) bonding separate conductive areas of an electrical component to a substrate using a conductive adhesive; and (b) bonding an area of the electrical component lying between the conductive areas to the substrate using a non-conductive adhesive.

Implementations of this aspect of the invention may include one or more of the following features. The method further includes forming, on the substrate, a pair of spaced conductive attachment areas to which the spaced conductive areas are bonded. The substrate includes a flexible sheet, e.g., a polyester film. The electrical component is an LED or diode. The conductive adhesive is a silver-filled epoxy adhesive. The non-conductive adhesive is an epoxy adhesive. The method further includes forming a membrane switch that includes the electrical component and the substrate. The method further includes hardening the conductive and non-conductive adhesives to secure the electrical component to the substrate.

In another aspect, the invention features an article comprising (a) a substrate; (b) an electrical component comprising separate electrical contacts; (c) a conductive adhesive bond between each of the separate electrical contacts and the substrate; and (d) a non-conductive bond between the substrate and a portion of the component that lies between the electrical contacts.

Implementations of this aspect of the invention may include one or more of the following features. The article includes a membrane switch. The substrate includes a flexible sheet, e.g., a polyester film. The electrical component is an LED or diode. The conductive adhesive is a silver-filled epoxy adhesive. The non-conductive adhesive is an epoxy adhesive. The non-conductive adhesive defines a barrier stripe between the adhesive bonds. The conductive bonds are squished.

In a further aspect, the invention features a membrane switch including (a) a flexible sheet substrate; (b) an electrical component comprising separate electrical contacts; (c) a conductive adhesive bond between each of the separate electrical contacts and the substrate; and (d) a non-conductive bond between the substrate and a portion of the component that lies between the electrical contacts; (e) the non-conductive bond comprising a barrier stripe between the adhesive bonds.

A “conductive adhesive” is a hardenable material that is sufficiently conductive so that, when properly applied and hardened, it provides an electrical contact point between an electrical component and a substrate to which the component is bonded. Preferred conductive adhesives exhibit as volume resistivity of less than about 5×10⁻³ Ohms/mil/cm, more preferably less than about 5×10⁻⁴ Ohms/mil/cm, when tested according to ASTM D2739-97.

A “non-conductive adhesive” is a hardenable material that is essentially non-shorting when placed between and in contact with two electrical contact points bonding an electrical component to a substrate. Preferred non-conductive adhesives exhibit a dielectric strength of greater than 2400 volts AC @ 1 mil (25 microns) when tested according to ASTM D149-81.

Other features and advantages of the invention will be apparent from the description and drawings, and from the claims.

### DESCRIPTION OF DRAWINGS

FIGS. 1, 1A and 1B are schematic backside views, looking through the substrate, of a portion of a membrane switch during various stages of a prior art production process. These views are taken from the backside of the substrate, looking through the substrate.

FIGS. 2 and 2A are schematic backside views of a membrane switch according to one embodiment of the invention, during various stages of production.

FIG. 3 is a front view of a membrane switch assembled by the process shown in FIGS. 2 and 2A.

FIG. 4 is a side view of the membrane switch shown in FIG. 1A.

FIG. 5 is a side view of the membrane switch shown in FIG. 2A.

### DETAILED DESCRIPTION

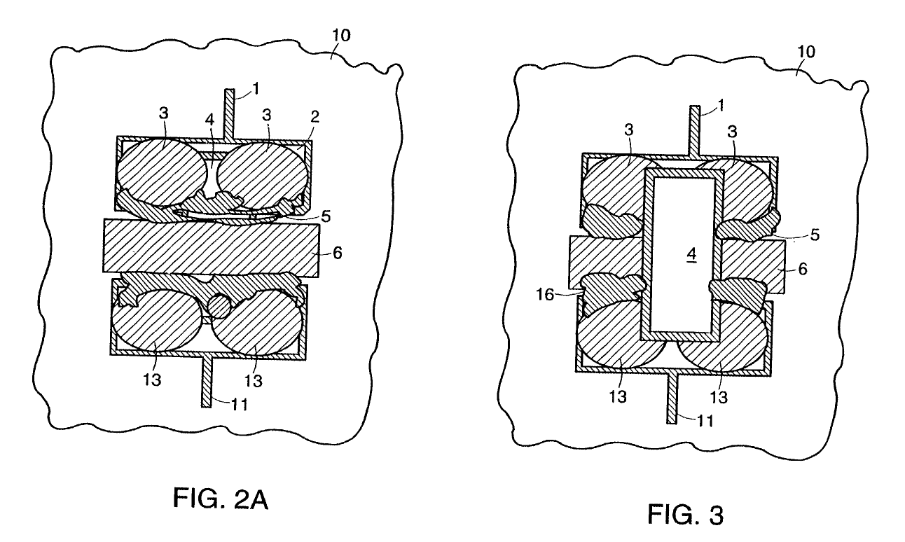

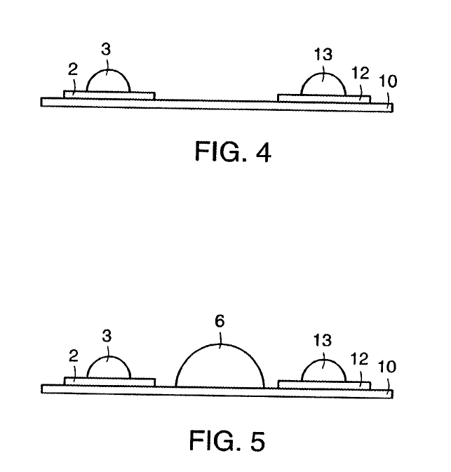

As shown in FIG. 2, to manufacture a membrane switch a conductive ink is first printed on a transparent flexible substrate 10 to form printed conductive traces 1, 11 and to define a pair of pads 2, 12, as explained above. Each bead of conductive adhesive typically measures about 0.025 inch by 0.050 inch by 0.006 inch.

Next, a bead of non-conductive adhesive 6 is placed between the pads 2, 12. After the non-conductive adhesive 6 is in place, and before it hardens, beads 3, 13 of conductive adhesive, e.g., silver-filled epoxy adhesive, are deposited on the substrate 10 (FIG. 2A). The non-conductive adhesive can be printed or dispensed as a line, a dot, or a number of dots. The non-conductive adhesive typically measures about 0.025 inch by 0.050 inch by 0.007 inch.

An LED 4 is then positioned on the beads 3, 13 as shown in FIG. 3. The non-conductive adhesive 6 squeezes out into a broader area 16 in the vicinity of the center of the LED 4, preventing the displaced regions 5 of conductive adhesive from bridging under the LED.

Finally, the non-conductive adhesive 6 and the conductive adhesive 3, 13 are hardened, e.g., by curing, to secure the LED 4 in place.

Suitable non-conductive adhesives include heat curable epoxy adhesives, cyanoacrylates, silicones and hot melts.

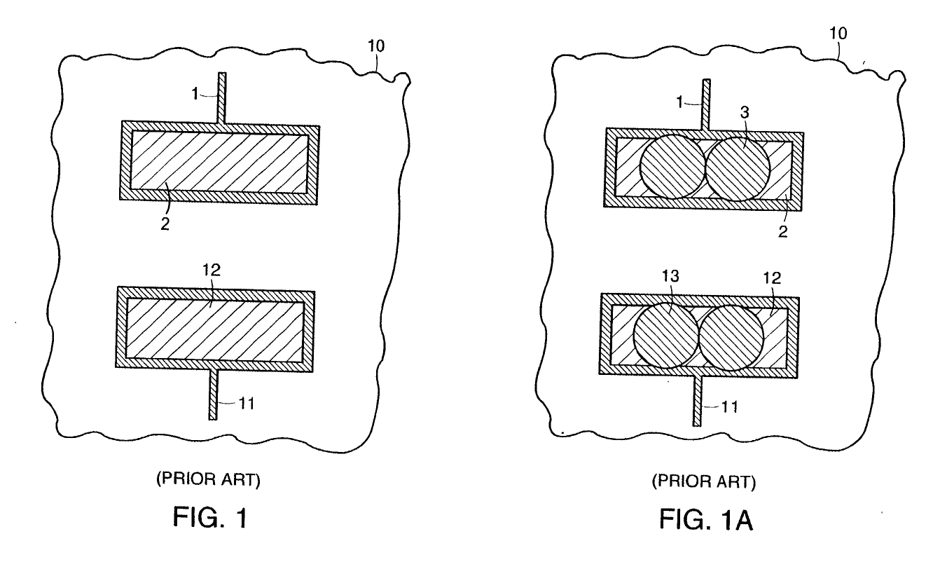

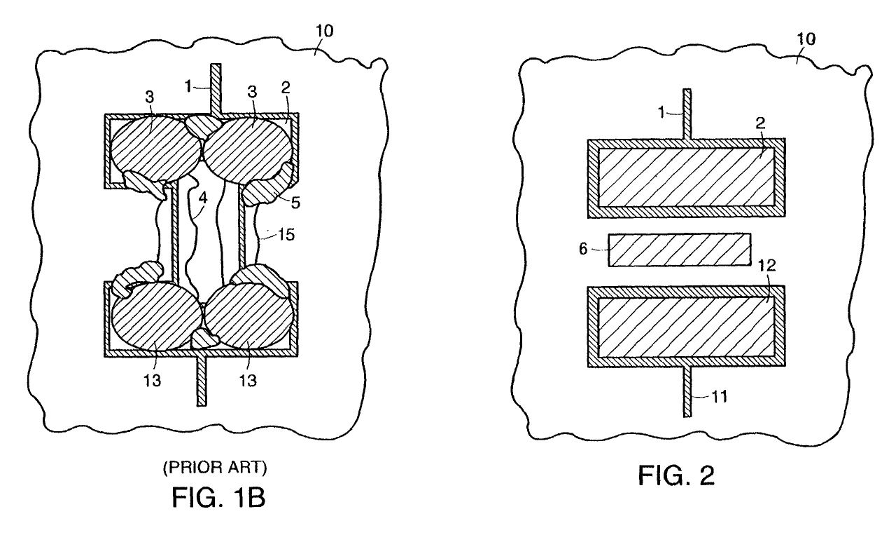

The bond strength of the LED to the substrate 10 in the configuration shown in FIG. 3 is generally higher than the bond strength in the prior art configuration shown in FIG. 1B for two reasons. First, the non-conductive adhesive 6 is stronger than most silver filled adhesives. Second, the total amount of surface area bonded by adhesive is greater. Depending on the adhesive deposition method (dispensed or printed), the increase in bond strength can be 2 to 4 fold. In some implementations, the bond strength is at least 10 pounds when measured by modified version of ASTM F1995-00.

Providing the non-conductive adhesive 6 generally prevents shorting of the electrical component, by providing a non-conductive barrier between the beads 3, 13 of conductive adhesive.

Other embodiments are within the scope of the following claims. For example, while LEDs and diodes have been discussed above, other electrical components may be bonded using the methods of the invention. Also, the methods of the invention may be used to bond electrical components to substrates other than flexible films, for example to printed circuit boards. The number and configuration of the pads could be different. The number and configuration of the adhesive dots and areas could be different.

### EXAMPLE

A number of LEDs (size 0603) were bonded to a 7 mil treated Mylar substrate having conductive pads as described above, using the following procedure. First, a non-conductive epoxy adhesive was printed in the center, between the two pads. Then, dots of conductive epoxy adhesive were dispensed on each of the pads. The LEDs were placed on the pads, and the substrate/LED assembly was heated for 3-5 minutes at 135° C. to cure the epoxy adhesives. The bond strengths were tested, using a push tester, with results ranging from 4 pounds to 9 pounds. No shorting was observed during electrical testing.

What is claimed is:

1. A method comprising
bonding separate conductive areas of an electrical component to a substrate using a conductive adhesive; and
bonding an area of the electrical component lying between the conductive areas to the substrate using a non-conductive adhesive.

2. The method of claim 1 further comprising
forming, on the substrate, a pair of spaced conductive attachment areas to which the spaced conductive areas are bonded.

3. The method of claim 1 wherein the substrate comprises a flexible sheet.

4. The method of claim 3 wherein the flexible sheet comprises a polyester film.

5. The method of claim 1 wherein the electrical component comprises an LED or diode.

6. The method of claim 1 wherein the conductive adhesive comprises a silver-filled epoxy adhesive.

7. The method of claim 1 wherein the non-conductive adhesive comprises an epoxy adhesive.

8. The method of claim 1 further comprising forming a membrane switch that includes the electrical component and the substrate.

9. The method of claim 1 further comprising
hardening the conductive and non-conductive adhesives to secure the electrical component to the substrate.

10. An article comprising
a substrate;
an electrical component comprising separate electrical contacts;
a conductive adhesive bond between each of the separate electrical contacts and the substrate; and
a non-conductive bond between the substrate and a portion of the component that lies between the electrical contacts.

11. The article of claim 10 comprising a membrane switch.

12. The article of claim 10 wherein the substrate comprises a flexible sheet.

13. The article of claim 12 wherein the flexible sheet comprises a polyester film.

14. The article of claim 10 wherein the electrical component comprises an LED or diode.

15. The article of claim 10 wherein the conductive adhesive comprises a silver-filled epoxy adhesive.

16. The article of claim 10 wherein the non-conductive adhesive comprises an epoxy adhesive.

17. The article of claim 10 wherein the non-conductive adhesive comprises a barrier stripe between the adhesive bonds.

18. The article of claim 10 wherein the conductive bonds are squished.

19. A membrane switch comprising
a flexible sheet substrate;
an electrical component comprising separate electrical contacts;
a conductive adhesive bond between each of the separate electrical contacts and the substrate; and
a non-conductive bond between the substrate and a portion of the component that lies between the electrical contacts;
the non-conductive bond comprising a barrier stripe between the adhesive bonds.
